(19) United States
(12) Patent Application Publication
(10) Pub. No.: US 2011/0194019 A1
(43) Pub. Date: Aug. 11, 2011

(54) OPTICAL IMAGING LENS AND ARRAY THEREOF

(76) Inventors: San-Woei SHYU, Taipei (TW); Huang-Chang Chen, Taipei (TW); Chih-Peng Wang, Taipei (TW); Te-Cheng Lin, Taipei (TW); Bo-Yuan Shih, Taipei (TW)

(21) Appl. No.: 13/016,579

(22) Filed: Jan. 28, 2011

(30) Foreign Application Priority Data
Feb. 11, 2010 (TW) 099203059

(51) Int. Cl. H04N 5/225

(52) U.S. Cl. 348/360; 348/E05.028

(57) ABSTRACT

A single-piece optical imaging lens and an array thereof are revealed. The optical imaging lens includes a lens and an image sensor arranged at an image-side surface of the lens. The lens includes an object-side surface, an image-side surface, an optical area, and a non-optical area. The optical imaging lens satisfies the following conditions: BFL/TTL=0.55˜0.81, OH/OD=1.0˜3.6. TTL is total length from the object-side surface of the lens on the optical axis to the image sensor. BFL is back focal length of the imaging lens. OD is the distance between an object on the optical axis and the object-side surface of the lens. OH is the largest height of an object vertical to the optical axis of OD. The single-piece optical imaging lens array is used to produce a plurality of single-piece optical imaging lenses by cutting.

### BACKGROUND OF THE INVENTION

The present invention relates to a single-piece optical imaging lens and an array thereof, especially to a super-thin single-piece optical imaging lens produced by cut of a single-piece optical imaging lens array and applied to mobile phones or image sensors such as CCD or CMOS.

Along with fast development of modern technology, electronics are getting more compact and multi-functional. A lot of electronic products such as digital still cameras, PC (personal computer) cameras, network cameras, mobile phones and even personal digital assistant (PDA) are equipped with an imaging lens. For convenience of easy carrying and humanized design, the imaging lens not only meets requirement of good image quality but also require more compact volume and lower cost. Especially for applications on mobile phones, the above requirements are getting more important.

Generally, the optical imaging lens is formed by a lens group (single-piece or multiple piece), an aperture, an IR (infrared) cut-off filter, a cover glass and an image sensor, as a single-piece optical imaging lens shown in TW200814902. Refer to FIG. 1, a single-piece optical imaging lens 1 consists of an image sensor 11, a lens holder 12 disposed over the image sensor 11, a lens module 13 with a part thereof mounted in the lens holder 12, and a cover glass 14 arranged in the lens holder 12 and covering the image sensor 11. Moreover, a lens 15 and an IR cut-off filter 16 are disposed inside the lens module 13. By the lens 15, an image is formed onto the image sensor 11. However, the connection of the lens holder 12 to the lens module 13 causes a large volume of the optical imaging lens 1.

Refer to FIG. 2, a stacked single-piece optical imaging lens revealed in Taiwanese Pat. No. 302630 includes an image sensor 21, a spacer 22, a cover glass 23, an IR cut-off filter 24, an aperture 25 and a lens 26 etc. The above elements are attached to each other directly so that the thickness of the optical imaging lens 2 is effectively reduced.

Although the thickness of the single-piece type optical imaging lens has been reduced, the volume of the optical imaging lens is still an important issue in design of the electronics when the volume of electronics is getting minimized. Especially for the single-piece type optical imaging lens, a certain length is still required for its back focal length. Thus there is a limit on the thickness of the single-piece type optical imaging lens.

In order to solve above problems, there is a need to provide an optical imaging lens whose focal length is reduced and is within a certain range. Moreover, optical components of the optical imaging lens are directly attached with each other, face-to-face so that the thickness of the optical imaging lens is reduced.

### SUMMARY OF THE INVENTION

Therefore it is a primary object of the present invention to provide a single-piece optical imaging lens whose total length and the back focal length are both reduced. Thus the thickness of the lens is significantly reduced so as to match compact and light-weighted requirements of mobile phones. Moreover, there is more space in the mobile phone provided for mounting other components. Furthermore, the single-piece optical imaging lens has more applications such as endoscope lens for stomach, short focus lens etc and the cost is also reduced due to components used with thinner thickness.

In order to achieve the above object, a single-piece optical imaging lens of the present invention includes a lens having an object-side surface an image-side surface, and an image sensor along an optical axis from an object side to an image side. The lens includes the object-side surface, the image-side surface, an optical area, and a non-optical area while the image sensor is arranged at the image-side surface of the lens. The lens satisfied the following conditions: BFL/TTL=0.55˜0.81, OH/OD=1.0˜3.6. TTL is total length from the object-side surface of the lens on the optical axis to the image sensor. BFL is back focal length of the imaging lens. OD is the distance between an object on the optical axis and the object-side surface of the lens. OH is the largest height of an object vertical to the optical axis of OD.

In order to achieve the above object, a single-piece optical imaging lens array of the present invention includes a lens array having plurality of lenses arranged in an array and an image sensor array having a plurality of image sensors arranged in an array and each image sensor is corresponding to one of the lenses. The single-piece optical imaging lens array is cut and separated into a plurality of single-piece optical imaging lenses. Along an optical axis from an object side to an image side, each single-piece optical imaging lens includes a lens having an object-side surface and an image-side surface, and an image sensor disposed on the image-side surface of the lens. The single-piece optical imaging lens satisfies following conditions: BFL/TTL=0.55˜0.81, OH/OD=1.0˜3.6.

TTL is total length from the object-side surface of the lens on the optical axis to the image sensor. BFL is back focal length of the imaging lens. OD is the distance between an object on an optical axis and the object-side surface of the lens. OH is the largest height of an object vertical to the optical axis of OD.

### BRIEF DESCRIPTION OF THE DRAWINGS

FIG. 1 is a schematic drawing showing structure of a conventional optical imaging lens;

FIG. 2 is a schematic drawing showing structure of another conventional optical imaging lens;

FIG. 3 is a schematic drawing showing optical structure of an embodiment of a single-piece optical imaging lens according to the present invention;

FIG. 4 is a schematic drawing showing optical structure of another embodiment of a single-piece optical imaging lens according to the present invention;

FIG. 5 to FIG. 14 are embodiments of a single-piece optical imaging lens according to the present invention respectively;

FIG. 15 is a perspective view of an embodiment of a single-piece optical imaging lens array according to the present invention;

FIG. 16 is an explosive view of the embodiment in FIG. 15.

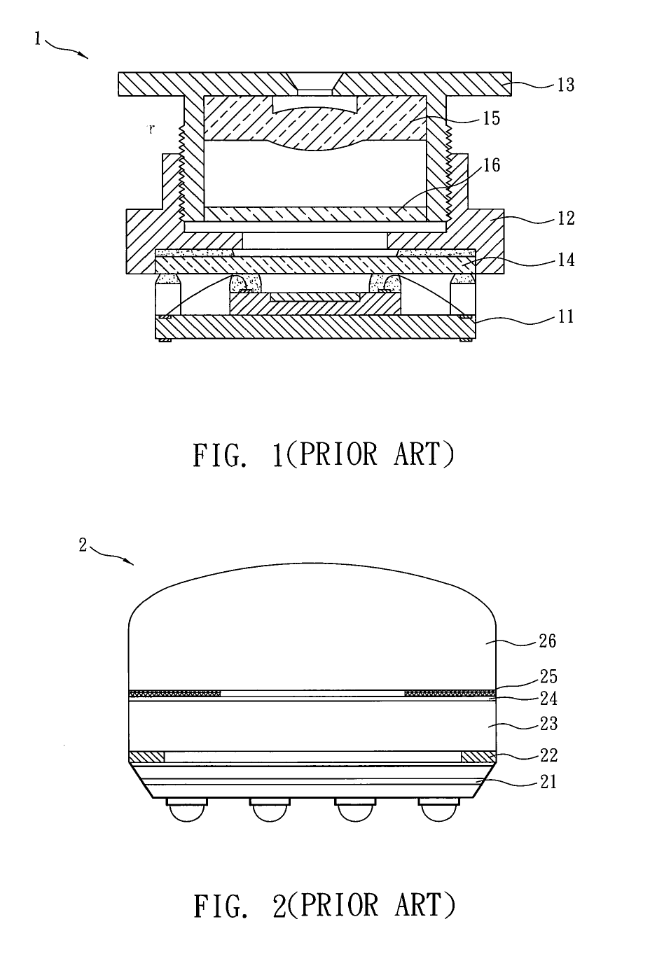

### DETAILED DESCRIPTION OF THE PREFERRED EMBODIMENT

The present invention reduces back focal of lenses by design of lenses. Not only the total thickness of the optical imaging lens is reduced, but the distance between the focal and the object is reduced for capturing images of larger objects.

A super-thin single-piece optical imaging lens satisfies following conditions:

BFL/TTL=0.55˜0.81 (1)

OH/OD=1.0˜3.6 (2)

wherein TTL is total length from an object-side surface of a lens on an optical axis to an image sensor;
BFL is back focal length of the imaging lens;
OD is the distance between an object on an optical axis and the object-side surface of the lens;
OH is the largest height of an object vertical to the optical axis of OD.

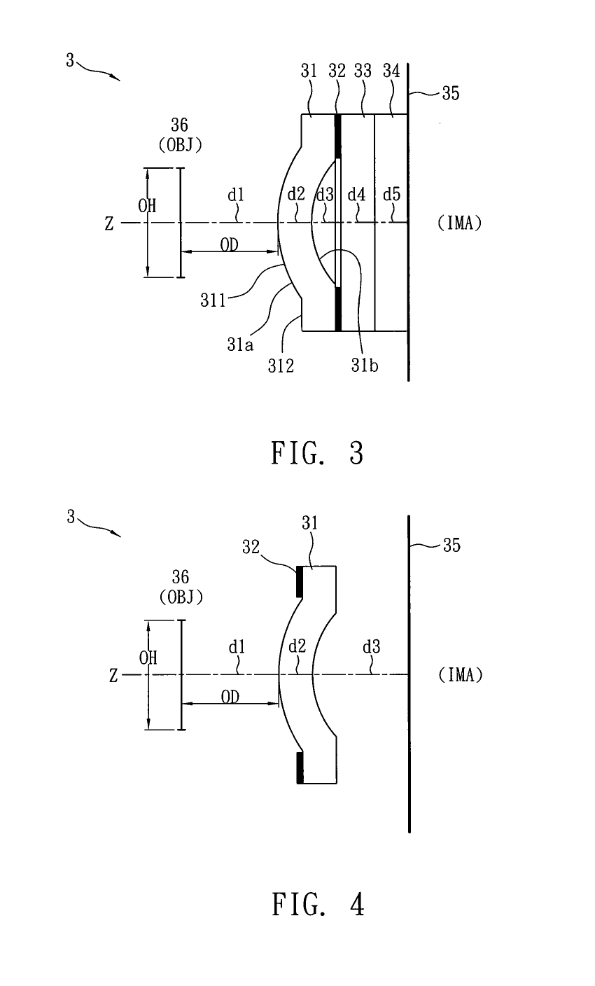

Refer to FIG. 3, from the object side to the image side along an optical axis Z, an embodiment of a single-piece optical imaging lens 3 of the present invention includes a lens 31, an aperture stop 32, an IR cut-off filter 33, a cover glass 34 and an image sensing chip 35. Moreover, an object 36 in front of the imaging lens 3 is an object whose image is to be captured. While capturing images, light from the object 36 firstly passes the lens 31, then through the IR cut-off filter 33, the cover glass 34 to form an image on the image sensing chip 35.

The lens 31 is made of plastic or glass with different shapes such as bi-convex, bi-concave, meniscus, plano-convex, plano-concave, etc.

The lens includes an object-side surface 31a, and an image-side surface 31b, an optical area 311 that light passes through, and a non-optical area 312 that light is unable to pass through. The object-side surface 31a, and the image-side surface 31b are convex surfaces or concave surfaces, spherical surfaces or aspherical surfaces. If they are aspherical surfaces, the aspherical surface formula is the equation 3:

$$Z = \frac{{ch}^{2}}{1 + \sqrt{( 1 - ( 1 + K ) {c}^{2} {h}^{2} )}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} \qquad ( 3 )$$

wherein Z is SAG Saggital depth is the distance between a point on an optical surface of the lens and the tangent plane that passes through the origin of the lens, c is curvature, h is height of the lens, K is conic constant, A4 to A14 respectively are 4th, 6th, 8th, 10th, 12th, 14th order aspherical coefficient.

The lens of this embodiment is a meniscus lens, as shown in FIG. 3, and both the object-side surface 31a, and the image-side surface 31b are both aspherical lenses.

The aperture stop 32 is a middle-positioned aperture that is attached directly to the non-spherical area 312 on the image-side surface 31b of the lens.

The IR cut-off filter 33 is a lens or thin film for filtering infrared light and formed by coating technology. In this embodiment, the IR cut-off filter 33 is a lens and is directly attached to the aperture stop 32.

The image sensor 35 can be a CCD (Charge Coupled Device) or CMOS (Complementary Metal Oxide Semiconductor).

Refer to FIG. 3, and the following list one includes data of optical surface number in order from the object side to the image side, the radius of curvature R (mm) of each optical surface on the optical axis Z, the on-axis surface spacing d (mm) of each optical surface on the optical axis Z, the refractive index N_{d} of the lens, and the Abbe's number ν_{d}, the focal length f (mm), the field of view/maximum field angle (FOV) and the object height (OH) (mm).

List one
Fno = 2.8
f = 1.0576
FOV = 57.7
OH = 661.26

| Optical surface | R | d(mm) | N_{d} | ν_{d} |
|---|---|---|---|---|
| 1 OBJ | ∞ | 600 | | |
| 2 R1* | 0.7369 | 0.358 | 1.487 | 70.2 |
| 3 R2* | −1.4620 | 0.706 | | |
| STOP | | | | |
| 4 IR | ∞ | 0.145 | 1.517 | 64.2 |
| 5 | | 0.300 | 1.517 | 64.2 |
| 6 IMAGE | ∞ | | | |

*represents aspherical surface

In this embodiment, the lens 31 is made of glass that has the refractive index N_{d} of 1.487, and the Abbe's number ν_{d} of 70.2. The IR cut-off filter 33 is also made of glass.

The effective focal length f of the optic system is 1.0576 mm and the values of parameters in equation 1 and equation 2 are shown in the list two.

List two

| | |
|---|---|
| BFL/TTL | 0.7630 |
| OH/OD | 1.1021 |

According to the list one, list two and the figures, the total length TTL of the single-piece optical imaging lens 3 is 1.5091 mm and the back focal BFL is 1.1515 mm. Thus both the lens length and the back focal of the single-piece optical imaging lens 3 are effectively reduced.

Refer to FIG. 4, from the object side to the image side along an optical axis Z, another embodiment of a single-piece optical imaging lens 3 of the present invention includes an aperture stop 32, a lens 31, and an image sensing chip 35. The structure of the lens 31 and the structure of the image sensing chip 35 are the same with the above embodiment while the aperture stop 32 is a front-positioned aperture.

The following list three includes data of parameters of the embodiment shown in FIG. 4.

List three
Fno = 2.8
f = 0.3749
FOV = 117.3
OH = 1970.70

| Optical surface | R | d(mm) | N_{d} | ν_{d} |
|---|---|---|---|---|
| 1 OBJ | ∞ | 600 | | |
| STOP | | | | |
| 2 R1* | 0.4252 | 0.206 | 1.809 | 40.4 |
| 3 R2* | −0.8459 | 0.293 | | |
| 4 IMAGE | ∞ | | | |

*represents aspherical surface

In this embodiment, the lens 31 is made of glass that has the refractive index N_{d} of 1.809, and the Abbe's number ν_{d} of 40.4. The effective focal length f of the optic system is 0.3749 mm and the values of parameters in equation 1 and equation 2 are shown in the list four.

List four

| | |
|---|---|
| BFL/TTL | 0.5870 |
| OH/OD | 3.2845 |

According to the list three, list four and the figures, the total length TTL of the single-piece optical imaging lens 3 is 0.4999 mm and the back focal BFL is 0.2934 mm. Thus both the lens length and the back focal of the single-piece optical imaging lens 3 are effectively reduced. The lens 3 is minimized and the applications of the optical imaging lens 3 are increased.

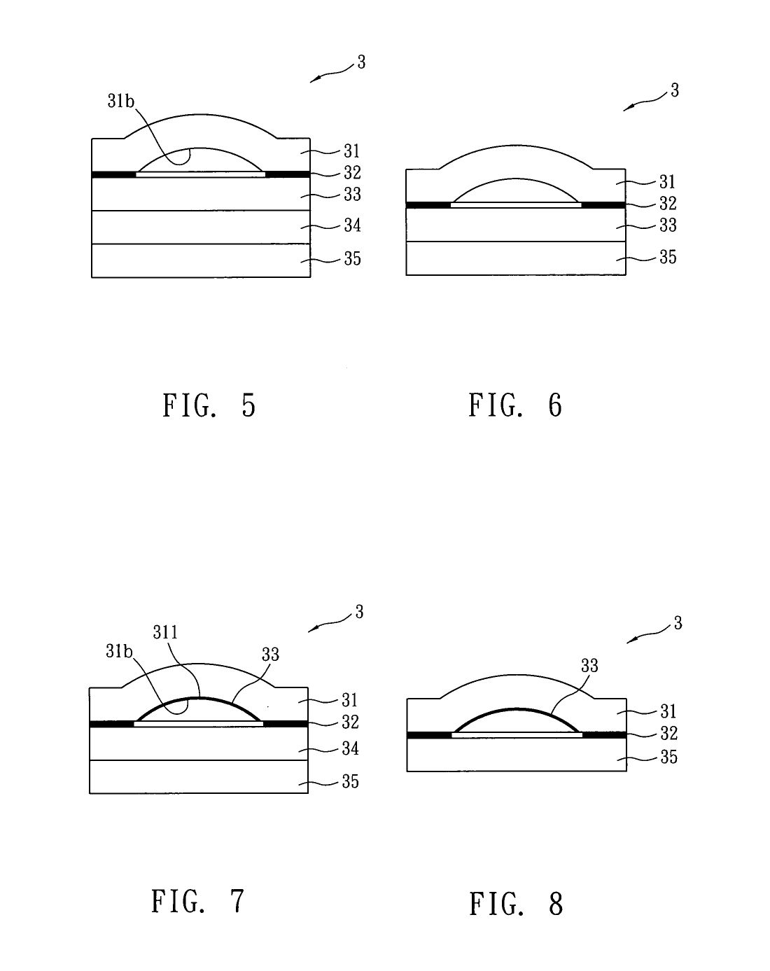

Refer from FIG. 5 to FIG. 14, further embodiments are revealed. These are embodiments are with different designs and the same functions. These embodiments also have similar optical structure to the above embodiments and satisfy the equation 1 as well as equation 2.

### Embodiment A

Refer to FIG. 5, from the image side (bottom side of the figure) to the object side (top side of the figure), the single-piece optical imaging lens 3 consists of an image sensor 35, a cover glass 34, an IR cut-off filter 33, an aperture stop 32, and a lens 31. The above optical components are attached to each other directly to form a stacked structure. The image-side surface of the cover glass 34 is directly attached to the image sensor 35. The image-side surface of the IR cut-off filter 33 is attached to the cover glass 34. The image-side surface of the aperture stop 32 is attached to the IR cut-off filter 33. The image-side surface 31b of the lens 31 is attached to the aperture stop 32. There is no gap between two adjacent optical components so that the total length of the imaging lens 3 is reduced effectively. The structure of each of the above optical components 31˜35 is the same with the above embodiment.

### Embodiment B

Refer to FIG. 6, this embodiment of the optical imaging lens 3 has the structure similar to the embodiment A while the difference is in that this embodiment is not disposed with the cover glass 34. The image-side surface of the IR cut-off filter 33 is directly attached to the image sensor 35. Thus the total length of the optical imaging lens 3 is smaller.

### Embodiment C

Refer to FIG. 7, this embodiment of the optical imaging lens 3 has the structure similar to the embodiment A while the difference is in that the IR cut-off filter 33 of this embodiment is formed on the optical area 311 of the image-side surface 31b of the lens 31 by coating technology. Thus the total length of the optical imaging lens 3 is further reduced.

### Embodiment D

Refer to FIG. 8, this embodiment of the optical imaging lens 3 has the structure similar to the embodiment C while the difference between the two embodiments is in that this embodiment is not arranged with the cover glass 34. The image-side surface of the aperture stop 32 is directly attached to the image sensor 35. Thus the total length of the optical imaging lens 3 is reduced.

### Embodiment E

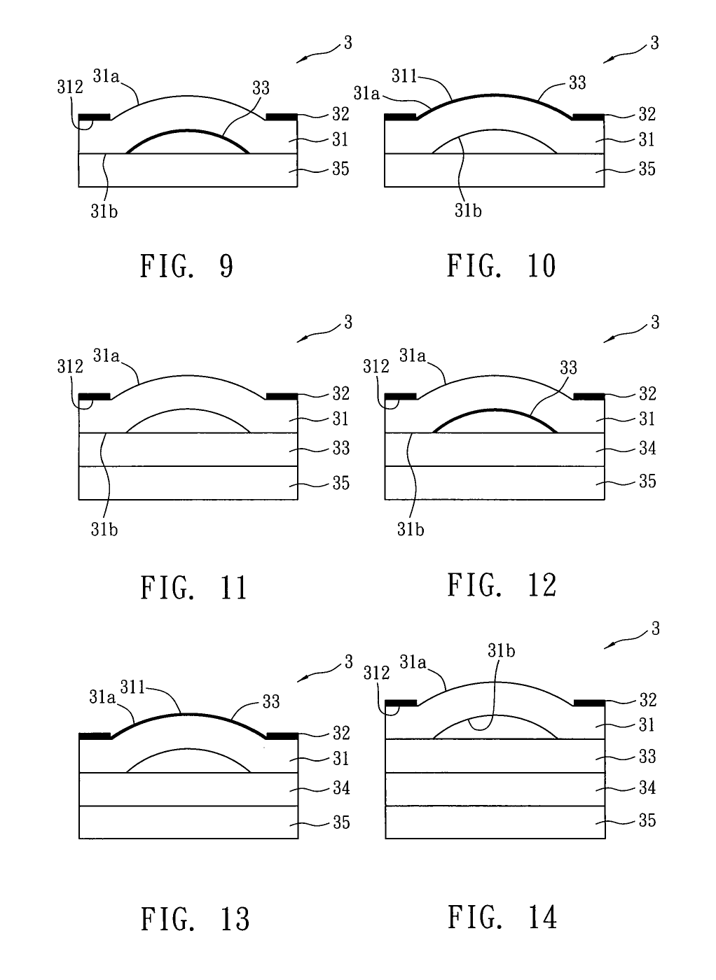

Refer to FIG. 9, the structure of this embodiment of the optical imaging lens 3 is corresponding to the embodiment in FIG. 4, with the structure similar to the embodiment D. The difference between the two embodiments is in that the aperture stop 32 of this embodiment is disposed on the non-optical area 312 of the object-side surface 31a of the lens 31 to form a front-positioned aperture, as the embodiment shown in FIG. 4. Thus the image-side surface 31b of the lens 31 is attached to the image sensor 35 directly and the total length of the optical imaging lens 3 is further reduced.

### Embodiment F

Refer to FIG. 10, this embodiment of the optical imaging lens 3 has the structure similar to the embodiment E while the difference between the two embodiments is in that the IR cut-off filter 33 of this embodiment is arranged at the optical zone 311 of the object-side surface 31a of the lens 31 and the image-side surface 31b of the lens 31 is directly attached to the image sensor 35.

### Embodiment G

Refer to FIG. 11, this embodiment of the optical imaging lens 3 has the structure similar to the embodiment B while the difference between the two embodiments is in that the aperture stop 32 of this embodiment is disposed on the non-optical zone 312 of the object-side surface 31a of the lens 31 and the image-side surface 31b of the lens 31 is directly attached to the IR cut-off filter 33 Thus the total length of the optical imaging lens 3 is reduced.

### Embodiment H

Refer to FIG. 12, this embodiment of the optical imaging lens 3 has the structure similar to the embodiment C while the difference between the two embodiments is in that the aperture stop 32 of this embodiment is disposed on the non-optical zone 312 of the object-side surface 31a of the lens 31 and the image-side surface 31b of the lens 31 is directly attached to the cover glass 34. Thus the total length of the optical imaging lens 3 is reduced.

### Embodiment I

Refer to FIG. 13, this embodiment of the optical imaging lens 3 has the structure similar to the embodiment H while the difference between the two embodiments is in that the thin-film shaped IR cut-off filter 33 is arranged at the optical zone 311 of the object-side surface 31a of the lens 31.

### Embodiment J

Refer to FIG. 14, this embodiment of the optical imaging lens 3 has the structure similar to the embodiment A while the difference between the two embodiments is in that the aperture stop 32 of this embodiment is disposed on the non-optical zone 312 of the object-side surface 31a of the lens 31 and the image-side surface 31b of the lens 31 is directly attached to the IR cut-off filter 33 Thus the total length of the optical imaging lens 3 is reduced.

In addition, for mass production and cost reduction, the above embodiments of the single-piece optical imaging lens 3 of the present invention can be produced in an array form. That means a single-piece optical imaging lens array is produced firstly and then the array is cut into a plurality of single-piece optical imaging lenses.

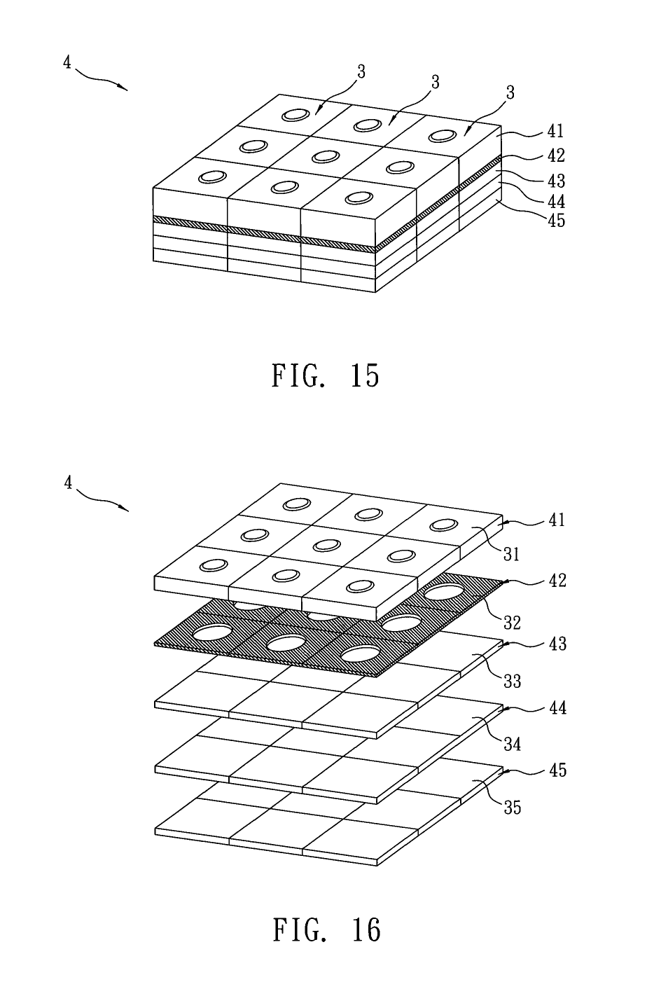

Refer to FIG. 15 and FIG. 16, take the above embodiment A of the single-piece optical imaging lens 3 as an example, but not limited to, an embodiment of a single-piece optical imaging lens array 4 is revealed. The single-piece optical imaging lens array 4 is formed by an image sensor array 45 having a plurality of image sensors 35, a cover glass array 44 having a plurality of pieces of cover glass 34, an IR cut-off filter array 43 having a plurality of IR cut-off filters 33, an aperture stop array 42 having a plurality of aperture stops 32, and a lens array 41 having a plurality of lenses 31 stacked with one another. The image sensor array 45, the cover glass array 44, the IR cut-off filter array 43, the aperture stop array 42 and the lens array 41 are respectively produced into a array-form body according to the optical design of the embodiment A of the single-piece optical imaging lens 3, as shown in FIG. 16. Then the arrays are stacked to form the single-piece optical imaging lens array 4, as shown in FIG. 15. Next the single-piece optical imaging lens array 4 is cut and separated to form a plurality of the single-piece optical imaging lenses 3 (embodiment A).

Still refer to FIG. 15 and FIG. 16, the embodiment of the single-piece optical imaging lens array 4 includes 9 single-piece optical imaging lenses 3 with structure similar to the embodiment A. Moreover, the shape of the single-piece optical imaging lens array 4 is not limited, it can be a disc-shaped array or a rectangular array. In this embodiment, the array is rectangular.

The single-piece optical imaging lens of the present invention is with reduced total length and decreased back focal length through the lens design. Due to limited space in the mobile phones, such lens can match compact and light weighted requirements of the mobile phones and more space is provided to other components mounted in the mobile phones. Moreover, the optical components used in the present invention is with thinner thickness and this is beneficial to the cost saving. Furthermore, the super-thin single-piece optical imaging lens of the present invention has more applications in various fields such as endoscope lens for stomach, short focus lens, etc.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A single-piece optical imaging lens comprising:
a lens having an object-side surface, an image-side surface, an optical area and a non-optical area; and
an image sensor disposed on the image-side surface of the lens along an optical axis from an object side to an image side;
wherein the single-piece optical imaging lens satisfies following conditions:
BFL/TTL=0.55˜0.81
OH/OD=1.0˜3.6
wherein TTL is total length from the object-side surface of the lens on the optical axis to the image sensor;
BFL is back focal length of the imaging lens;
OD is the distance between an object on an optical axis and the object-side surface of the lens;
OH is the largest height of an object vertical to the optical axis of OD.

2. The device as claimed in claim 1, wherein the image-side surface of the lens is directly attached to the image sensor.

3. The device as claimed in claim 1, wherein the optical imaging lens further includes at least one optical component selected from following optical components or their combinations: an aperture, a cover glass, an infrared cut-off filter; the optical component is directly attached to the lens or the image sensor; if the optical imaging lens includes at least two optical components, the two optical components are attached with each other directly to form a stacked structure.

4. The device as claimed in claim 3, wherein the infrared cut-off filter is a thin-film infrared cut-off filter formed on the image-side surface of the lens or the optical area of the object-side surface of the lens by coating technology.

5. The device as claimed in claim 3, wherein the aperture is arranged at the image-side surface of the lens or the non-optical area of the object-side surface of the lens.

6. A single-piece optical imaging lens array comprising:
a lens array having a plurality of lenses arranged in an array; and
an image sensor array having a plurality of image sensors arranged in an array and each image sensor is corresponding to one of the lenses;
wherein the single-piece optical imaging lens array is cut and separated into a plurality of single-piece optical imaging lenses;
wherein the single-piece optical imaging lens includes:
a lens having an object-side surface, and an image-side surface; and
an image sensor disposed on the image-side surface of the lens along an optical axis from an object side to an image side;
the single-piece optical imaging lens satisfies following conditions:
BFL/TTL=0.55˜0.81
OH/OD=1.0˜3.6
wherein TTL is total length from the object-side surface of the lens on the optical axis to the image sensor;
BFL is back focal length of the imaging lens;
OD is the distance between an object on an optical axis and the object-side surface of the lens;
OH is the largest height of an object vertical to the optical axis of OD.

7. The device as claimed in claim 6, wherein the image-side surface of the lens is directly attached to the image sensor.

8. The device as claimed in claim 6, wherein the optical imaging lens further includes at least one optical component array selected from following optical component arrays or their combinations: an aperture array, a cover glass array, an infrared cut-off filter array; the optical component array is directly attached to the lens array or the image sensor array; if the optical imaging lens array includes at least two optical component arrays, the two optical component arrays are attached with each other directly to form a stacked structure.
